(19) United States
(12) Patent Application Publication
(10) Pub. No.: US 2005/0213433 A1
(43) Pub. Date: Sep. 29, 2005

(54) Localized signal radio adjusted clock

(76) Inventor: Pat Y. Mah, Kowloon (CN)

Correspondence Address: Curt Harrington, Suite 250, 6300 State University Drive, Long Beach, CA, 90815, US

(21) Appl. No.: 10/809,621

(22) Filed: Mar. 24, 2004

(51) Int. Cl. G04C 11/02; H04J 3/00

(52) U.S. Cl. 368/47

(57) ABSTRACT

An individual circuit control heuristic provides multi-system time broadcast system capability. A multi-band antenna is connected to a receiver integrated circuit having access to a series of filter banks corresponding to the propagation frequencies used by each broadcast transmission area. An MCU (microprocessor clock unit) is controllably connected to the receiver and to a clock display. An optional user input can enable a user's intervention, such as when changing time broadcast areas. Generally scanning for radio controlled clock signal is automatic and without user's intervention. A period of 2 minutes is allotted to synchronize the automatic clock time signal. The MCU will periodically check for the presence of this radio controlled clock signal at an average, but randomized time spacing to avoid any possible collision with a periodically occurring interference signal. A logic flow is used to limit radio frequency receiver usage in accord with pre-programmed precepts.

### FIELD OF THE INVENTION

The present invention relates to the field of time keeping devices and more particularly to a more precise self correcting chronometer based upon a comparison between a precise time data radio signal and an on-board computer and which is an improvement allowing utilization of a single dual time chronometer to be controlled by differentiated transmitter time synchronization signals.

### BACKGROUND OF THE INVENTION

Audible Radio transmitted time signals have been in use for some years, with a transmitter electrically connected to an extremely accurate atomic clock. In more recent years and with the proliferation of digital equipment, and the need to receive the time signal in digital transmission format, countries and country areas have adopted systems of transmission of time data. Because the atomic clocks are extremely accurate, the time for distance travel of the timing signal is significant. The distance affects both the time of propagation and the quality of the propagation signal. Most scientific users of closely synchronized clock data will go to extra lengths to cure the coordination problem with an atomic clock. For non-scientific users, such as wristwatch users, the ability to keep accuracy constantly under one second and to further avoid ever having to re-set their personal watches is paramount.

Atomic radio controlled clocks owned by governments are typically accurate to one second every million years. Some governments broadcast atomic, electronically encoded signals with their own national time via long wave transmitters in the frequency range of 40 to 80 kHz. There are several of these government based transmitters placed in different countries. One transmitter is located in the United States which provides time broadcast coverage to the North American continent. Another transmitter, located near London, covers the United Kingdom and surrounding areas, while a transmitter located in Germany which covers the central European continent. There are two more transmitters in Japan which provide broadcast coverage for East Japan and West Japan.

These single government, atomic clock broadcast signals are each a single frequency with different radio frequency signals received from one transmitter. The system of different clocks and different transmitters is not suitable for a traveler who travels between these different broadcast coverage regions. A single user's clock would have a single area frequency and can only be used in that region only. It is not practical to have a user own and carry a separate time piece for each time broadcast area in which travel occurs.

Even if the governments were to join together to offer coordinated local transmission points for the radio signal, there would be interference between competing signals. The competition would cause aliasing and destructive interference when offered on the same frequency. The manner of signal propagation is a binary coded decimal format where four binary digits are used to represent one decimal number by reducing and restoring the carrier power. The binary coding includes information as to the correct minutes, hours, days, universal time hour, universal time correction, year, leap year indicator, warning, and daylight saving time bits. All of this information is contained within a single one minute cycle of time, and thus even with no other advance information whatsoever, 100% of the information can be had within a time period of one minute.

Another problem with the use of radio frequency receivers is the power demanded by the receiver. Microprocessor based electronic time mechanisms require very little power, and even proportionately less compared to a radio receiver. Where power is not limited, a radio receiver can be energized continuously, and a control microprocessor can insure a continuous series of updates.

The propagation frequency is long wave, but regardless of propagation frequency, a fixed clock installation can easily benefit from an external antenna. Atomic clock information modulates a fixed propagation frequency carrier. More mobile and compact structures have the possibility of being in an enclosure which could possibly block the time synchronization signal. The act of leaving the receiver on until the full synchronization signal is received would drain the battery of a typical watch or small electric clock in a short time. Further, the presence of interfering noise from other electronic components is often experienced with portable miniature electronic equipment. Thus, for portable electronic equipment it is very likely that it will spend a significant portion of its day in positions where it could not receive the atomic clock synchronization signal.

Given the miniaturization required by personal time pieces and wrist watches, the on-board space available for radio receivers and time update circuitry, the solution to the problem of providing time update ability in various areas cannot translate into providing separate chronometer for each area. What is therefore needed is an ability to provide multi-area time synchronization capability in a single package for use with a single chronometer. Also needed is the multiple ability for the detection of each time area broadcast signal so that the chronometer can be updated with the proper time while in each time broadcast area.

### SUMMARY OF THE INVENTION

An individual circuit control heuristic provides multi-system time broadcast system capability. A multi-band antenna is connected to a receiver integrated circuit having access to a series of filter banks corresponding to the propagation frequencies used by each broadcast transmission area. An MCU (microprocessor clock unit) is controllably connected to the receiver and to a clock display. An optional user input on the unit enables a user's intervention, such as when changing time broadcast areas. Generally scanning for radio controlled clock signal is automatic and without user's intervention. A period of three to five minutes is allotted as a window within which to receive the full one minute digital signal in order to synchronize the automatic clock time signal. This “minimum time period necessary to receive said binary coded time signal”, is used in the case where the microprocessor time signal may be considered to be completely unaware of the correct time. Being completely unaware of the time, it cannot “time” its turn-on and turn of the receiver to exactly coincide with the start and finish of the digital time signal. In this instance, assuming no problems with propagation, a two minute window period would insure the complete reception of a full, one minute time message.

Further with regard to a “blind” actuation or one wherein the full two minute period is required (such as battery change or in traveling from one area to another), the Microprocessor clock unit will periodically check for the presence of this radio controlled clock signal at an average time spacing, which is preferably randomized to avoid any possible collision with a periodically occurring interference signal. A two hours example of an average time period may be preferred in an initiation mode. Again, upon initial energization in an environment where a signal cannot be acquired, there may be provided an ability to initially set the time manually so that usage will not be negated and so that the user will not mistakenly suspect a problem.

To further save power, after initial synchronization, the Microprocessor clock unit is programmed to utilize a “second, even smaller minimum time period necessary to receive a portion of the binary coded time signal” necessary to correct time deviations of a few seconds, typically from five to ten seconds in a day or 5 seconds in a half day, etc. Once full initial synchronization has occurred, and assuming that the microprocessor clock does not have an extreme difference in run time rate with respect to the atomic clock driven signal it can receive, the microprocessor clock unit can reliably turn on the radio receiver for (1) just long enough to read the magnitude difference in seconds, as well as (2) having the ability to time the point within the one minute frame in which the seconds data is expected to be given.

Therefore, the microprocessor clock unit can not only plan to take in a much abbreviated signal, it can also know when to energize the receiver in order insure that it fits within a smaller seeking “window”. The size of the smaller “window” can be pre-specified or it can be based upon the microprocessor clock unit's own measurement of its run time rate difference. As an example, the “minutes” portion of the WWVB time code format fits within a time period of about ten seconds. Acquiring the timing of the minutes portion of the time code would would be significant enought to correct seconds and give an accurate minutes count.

Where the framing window clearance was fixed at five seconds for example, the receiver could be initialized to turn on at five seconds before the ten second minutes window in order to correct any time difference amounting to a few seconds. In the alternative, the receiver could be initialized to turn on at five seconds before a one second timing pulse which marks the beginning of the one minute time frame. In this case, the “second, even smaller minimum time period necessary to receive a portion of the binary coded time signal” is reduced to about six seconds.

Where the microprocessor clock unit is programmed to record and keep track of the run time difference, and can thus accurately predict the expected time difference, it can for example energize the receiver a second or two ahead of the expected time which it should receive a one second timing marker. This would reduce the energization time to about three seconds.

As a result, the “second, even smaller minimum time period necessary to receive a portion of the binary coded time signal” is designed to avoid receiving the clock information packet in full (which has been shown, even under perfect received propagation take as much as almost two minutes). Instead it is programmed to receive the “signature” of the atomic clock information corresponding to the transmission area or region and then turn itself into low power mode to save battery power by not activating the receiver. Under this “local synchronization expectation”, the Microprocessor clock unit unit will energize the receiver to receive the clock information packet either periodically (with some randomness element) or at a periodicity which reflects keeping the update to a minimum. For example, if it is known over time that a run time rate for the microprocessor clock unit differs from the atomic clock signal by a difference of one second per week, the periodicity to correct for one second might be run weekly. Larger run time differences may result in more frequent updates. A default rate of once in every 24 hours to collect an internal timing error is reasonable absent a run time difference prediction mechanism. The clock system may also have an input for “distance from the atomic clock broadcasting source” so that the microprocessor clock unit could further make up for the speed of light time necessary to propagate the signal from the atomic clock signal source to the receiver.

Should the clock move to a different broadcast area, the Microprocessor clock unit unit will recognize the absence of the last “signature” of the atomic clock information corresponding to the transmission area or region and then enter a re-set mode taking no more than two hours to automatically sync to a new radio controlled clock broadcast transmission signal. Should the clock or watch experience the complete absence of any clock synchronization signal, the standard chronometer will proceed to continue to record time based upon the last atomic clock broadcast transmission signal received. In regions such as the southern part of England or the northern part of France, for example, a unit can receive two different radio controlled clock broadcast transmissions. The present invention circumvents this situation by providing a mechanism to allow the display of the right time regardless of whether the right atomic clock signal of this location has been received or not.

Random receiving mode in the short term is be helpful in avoiding interference if noise signal is periodic. However, to cover some of the worst case situations where a battery powered wristwatch or chronometer might be absent from access to a broadcast transmission signal, for extended periods, an exponential/logarithmic decay could be programmably invoked to avoid fruitless actuation of the receiver. This could be used, for example, to meet situations where the timepiece was stored in a metal box for a period of time, or where the user spent a significant amount of time in an area where no signal was available. By way of example only, where the average time for initially randomly seeking a broadcast transmission signal is one hour, the times for re-acquisition of signal attempts might decay to occur an average of two hours later, and then four hours later, eight hours later, 1 day later, 2 days later, four days later, etc.

As an example of a short term one hour acquisition period (such as the first re-try after failure of acquisition) the next time period might be one of 1 hour, 70 minutes, 50 minutes, 80 minutes, or 40 minutes. In this example the average period difference is still 1 hour.

As a dual-time chronometer, the clock shows two times, the home time and the current time on the display. Home time is the time of the locaton where the user predominantly resides. Current time is th etime of the location to which the user is travelling. Usually the home time is fixed once it is set. Should a user travel to a new location and wishes to permanently stay, or to change to a new home time, the displayed current time should be the home time as well. The present invention includes a simple mechanism to allow a user to alter the home time setting.

### BRIEF DESCRIPTION OF THE DRAWINGS

The invention, its configuration, construction, and operation will be best further described in the following detailed description, taken in conjunction with the accompanying drawings in which:

FIG. 1 is a schematic block diagram of a first configuration in which a multi band antenna has a series of filters selectably switched by a band switch connected to a receiver; and

FIG. 2 is a logic block diagram illustrating one set of control logic possibilities.

### DETAILED DESCRIPTION OF THE PREFERRED EMBODIMENT

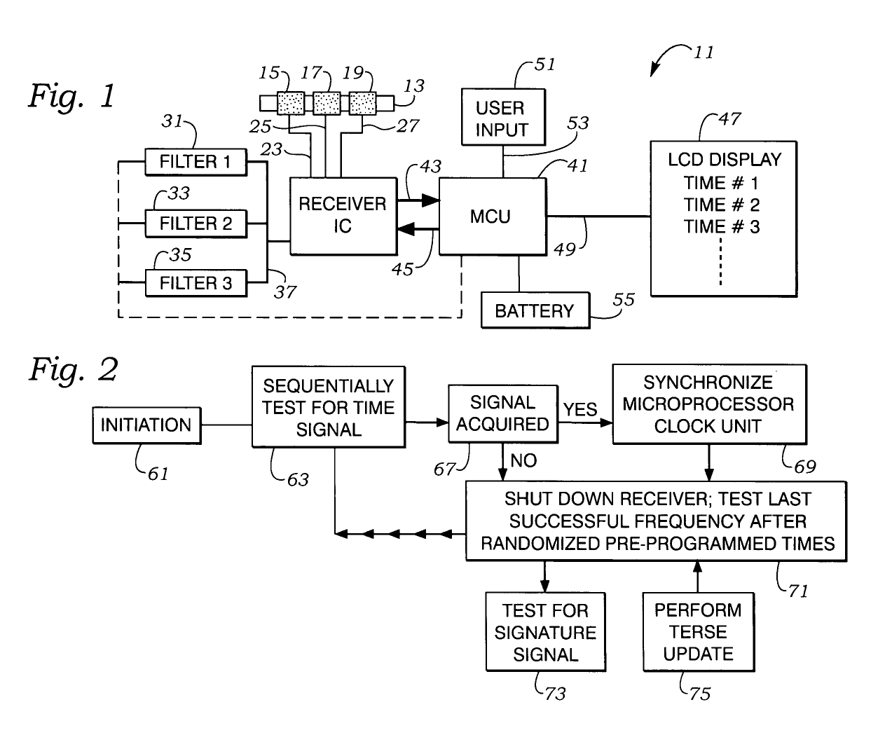

In general, a radio frequency receiver provided herein can receive and decode atomic clock time information package sent by transmitters in different regions. Referring to FIG. 1, a clock system 11 includes a physical antenna structure 13 which may or may not be ferromagnetic, and which supports a series of conductive antenna elements 15, 17, and 19. Conductive antenna element 15 is connected to a radio receiver integrated circuit “receiver ic” 21 via a connection line 23 which may be a multi conductor connection. Similarly, conductive antenna elements 17 and 19 are connected to a radio receiver integrated circuit 21 via connection lines 25 and 27.

Radio receiver integrated circuit 21 has available a series of filter elements 31, 33, and 35 which may be physical filters or mathematical models. Filter elements 31, 33, and 35 may be connected to radio receiver integrated circuit 21 via a connection 37, or they may be made available to or connected to a microprocessor clock unit 41.

Radio receiver integrated circuit 21 is also connected to microprocessor clock unit 41 by both a receiver output/MCU input connection 43 and a receiver input/MCU output connection 45. Microprocessor clock unit 37 is also connected to a liquid crystal display 47 by way of a connection 49. Preferably the liquid crystal display 47 will also be enabled to sequentially or simultaneously display a first time datum, which may be referred to as one or more of a “home time” and a second time datum which may be referred to as one or more of a “travel time” which may be susceptable to being updated. This will enable a traveller to always be on time with respect to the local time which is under the influence of the local time synchronization signal, while not losing the “home time” signal even though outside of the “home time” synchronization signal. Since such visitations into the “travel time” are expected to be of a shorter duration than the “home time”, the “home time” will be conserved while on travel, and then updated while in the home territory. When in the home territory, the “travel time” or times will be continued or erased. Home or travel times are represented by the quantities “TIME #1”, “TIME #2”, etc.

Depending on the specifics of the microprocessor clock unit 37 and the receiver integrated circuit 21, the control may be more automatic within the receiver integrated circuit 21 with abbreviated control signals sent over the receiver input/MCU output connection 45, or with more slavish input to the receiver input/MCU output connection 45 where the receiver integrated circuit 21 can receive filter timing or sampling signals. The microprocessor clock unit 37 may also have an optional user input 51 connected by a connection 53. User input could include standard inputs such as standard or military (24 hour) time display, illumination options, or other user specified inputs. The only limitation to the user inputs would be the physical input structures carried by the clock system 11. One user input may be available to re-initiate the clock system 11 either as a test for ability to acquire a radio frequency time synchronization or for the user to force acquisition of a new radio frequency time synchronization signal, when the user travels to a new broadcast time signal area.

The MCU 41 is connected to a battery 55, as the clock system 11 is expected to operate from a limited power supply. Indeed the rationale for powering up for only long enough to read only as much of the digital time signal as is necessary is done in response to the requirement that the battery not be significantly large. As will be seen, the ability to perform a terse update will provide a further battery savings.

The microprocessor clock unit 37 will be supplied in a programmed state to include the options previously discussed. Referring to FIG. 2, an INITIATION block 61 is the starting point for logic on initial power up, as for example the first introduction of battery power or the introduction of battery power after a change of battery. The user input 51 may provide the ability for users to set the time, particularly where the user may have powered up in a location without access to the time broadcast synchronization radio signal. In terms of logic flow, user time setting intervention, if it is allowed at all, will proceed without interference of the programmed steps.

From the INITIATION block 61, the logic flows to a SEQUENTIALLY TEST FOR TIME SIGNAL block 63. It is here that the receiver integrated circuit 21 is energized and presence of a received time signal is tested. This can occur in rapid sequence or it can occur in accord with the normal progression of pass/fail signal testing. It is stated as being sequential as it may preferably remember which was the last successful frequency and test for that frequency first. On subsequent actuations, it could test for the main frequency or test its other frequencies once the first frequency has been tested several times. It may also be programmed that when the logic flow arrives from the INITIATION block 61, rather than from another looped path, that the first test sequentially test all frequencies for the minimum time needed to acquire a signal and report all three results. All frequency testing may be preferable immediately upon initiation so that a user will not mistake the lack of an initial result as being a product of a defective unit.

The logic next flows to a SIGNAL ACQUIRED decision block 67, with a “no” result logically leading back to the input of a SHUT DOWN RECEIVER; TEST LAST SUCCESSFUL FREQUENCY AFTER RANDOMIZED PRE-PROGRAMMED TIMES block 71. This block makes decisions based upon pre-programmed time intervals, possibly in combination with receipt of signal success history. A “yes” result leads to a SYNCHRONIZE MICROPROCESSOR CLOCK UNIT block 69 where the time information is transferred to the microprocessor time keeper which uses the information as a starting point from which to proceed keeping time.

The SHUT DOWN RECEIVER; TEST LAST SUCCESSFUL FREQUENCY AFTER RANDOMIZED PRE-PROGRAMMED TIMES block 71 also receives logic flow from the SYNCHRONIZE MICROPROCESSOR CLOCK UNIT block 69. As a result, block 71, in the configuration shown, will may have partial or complete responsibility selecting the frequency for block 63, but will likely have complete responsibility for all recycle activity.

For example, one time table can be invoked where each energization of the receiver integrated circuit 21 is successful, for example to either (1) continue to energize the receiver integrated circuit 21 over longer and longer times until a maximum time spacing is achieved, or (2) continue to lengthen the times between energizations of the receiver integrated circuit 21 until the time difference correction synchronized upon a given receiver integrated circuit 21 energization reaches a threshold limit. In other words, the periodicity of synchronization can decrease until the correction exceeds a threshold, say one second, after which the periodicity is reduced or held constant.

In another example, especially with regard to control of block 63, a first frequency could be used for the initial test, with a second frequency used to test for signal presence in an average of an hour, with a third frequency used to test for signal presence in an average time of one or two hours later, etc.

As yet another example, another time table can be invoked where one or a number of the energizations of the receiver integrated circuit 21 is un-successful. For example to either (1) start sequential frequency testing or (2) to alter the periodicity of re-test or to sequentially test at the time of the next receiver integrated circuit 21 energization.

Depending upon the particular set of characteristics matched, the SHUT DOWN RECEIVER; TEST LAST SUCCESSFUL FREQUENCY AFTER RANDOMIZED PRE-PROGRAMMED TIMES block 71 can send the logic back to the SIGNAL ACQUIRED decision diamond 67 to hopefully perform a perfunctory synchronization. For example, the logic would not be sent back each and every time to the SEQUENTIALLY TEST FOR TIME SIGNAL block 63, particularly if the system 11 has never experienced a different time broadcast area. Simplicity of programming will yield an economy of power, programming and cost, but the sophistication of programming to optimize the minimization of the initiation of the receiver integrated circuit 21 in order to conserve power. Where the time difference threshold is utilized, the system 11 may be programmed to go days without the need to initiate the receiver integrated circuit 21.

Where the clock system 11 has established a track record of synchronization, especially where the magnitude of the synchronization is small, the SHUT DOWN RECEIVER; TEST LAST SUCCESSFUL FREQUENCY AFTER RANDOMIZED PRE-PROGRAMMED TIMES block 71 can send the logic to a TEST FOR SIGNATURE SIGNAL block 73 where a low-power rationale will enable the energization of the receiver integrated circuit 21 at a very abbreviated time to limit the information received to the minimum amount of information necessary to update the expected de minimis time difference between the internal time kept by the microprocessor clock unit 41 and the broadcast time synchronization radio signal. The logic then flows to the PERFORM TERSE UPDATE block 75 where the small expected time difference updates the microprocessor clock unit 41 whereupon the logic flows back to block 71.

The logic shown in FIG. 2 generally always returns to block 71 as an example of the provision of a configuration which will always send the logic out for receiver testing and synchronization with no other actions. User programmability of the microprocessor clock unit 41 may be had from a user input 51 and may include the ability to configure all of the logic considerations seen in FIG. 2. Further, the clock system 11 may be amenable to be programmed from a laptop or personal computer. Programming input from a personal computer to the clock system 11 may be terse, but the programming menu presented to the user may be expansive. User input 51 can be buttons, electrical connection, or it may be an optical input such as an infrared input or a normal optical input. The clock system 11, in the form of a wristwatch may be programmable simply by placing it in front of one corner of a computer screen. Bit-type signaling can be used to convey programming to the clock system 11 as well as computer time input and other information.

While the present invention has been described in terms of a chronometer which provides automatic time update calibration and power conservation without the possibility for self imposed correction actions which include the ability to operate in more than one broadcast time update area, the present invention may be applied in any situation where frequency and receipt testing and power conservation is desired by the use of a decision based system, with correction ranging from full data acquisition to a de minimis error correction under conditions of low power operation.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

1. A clock system comprising:
a receiver circuit for receiving a binary coded time signal, comprising:
a microprocessor clock unit connected to said receiver circuit and programmed to energize said receiver circuit for a minimum time period necessary to receive said binary coded time signal, and to shut said receiver circuit off after said minimum time period; and
a clock display connected to said microprocessor clock unit for displaying time.

2. The clock system as recited in claim 1 wherein said minimum time period necessary to receive said binary coded time signal is sufficient to insure receipt of a full one minute time signal within said minimum time period.

3. The clock system as recited in claim 1 wherein said minimum time period necessary to receive said binary coded time signal is sufficient to insure receipt of a small portion of a full one minute time signal necessary to provide a time update having a magnitude of no more than five seconds.

4. The clock system as recited in claim 1 wherein said microprocessor clock unit includes programming for a separate first time storage and a separate second time storage and retrieval to enable a user to energize said receiver circuit for a minimum time period necessary to receive said binary coded time signal in said first time storage and without disrupting said second time storage.

5. The clock system as recited in claim 4 wherein said separate first time storage and said separate second time storage are each associated with a separate binary coded time signal.

6. The clock system as recited in claim 4 wherein said first said time storage is not disrupted in absense of said binary coded time signal.
